(19) United States
(12) Patent Application Publication
(10) Pub. No.: US 2013/0049662 A1
(43) Pub. Date: Feb. 28, 2013

(54) FAN CONTROL SYSTEM AND METHOD

(71) Applicants: KHOR JOO KEONG, Shenzhen City (CN); WEN-KAO FENG, Shenzhen City (CN)

(72) Inventors: KHOR JOO KEONG, Shenzhen City (CN); WEN-KAO FENG, Shenzhen City (CN)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 13/528,927

(22) Filed: Jun. 21, 2012

(30) Foreign Application Priority Data
Aug. 24, 2011 (CN) 201110243325.9

(51) Int. Cl. G05B 11/01

(52) U.S. Cl. 318/452

(57) ABSTRACT

A fan control system includes an alternative current (A/C) source, a programmable logical controller (PLC), a switch module, and a fan module. The PLC includes a detecting module. The switch module is connected to the A/C source. The fan module is connected to the switch module. The fan module includes a plurality of fans. The PLC is adapted to control the switch module thereby changing a power level output to the fan module, according to an ambient temperature of the fan module and an air pressure difference between a cold channel and a hot channel of the fan module in turn. If the pressure difference is smaller than a predefined value, the plurality of switches are switched by the PLC to provide a higher power to the fan module.

### BACKGROUND

The disclosed embodiments relate to fan control systems and fan control method, especially to a fan control system and a fan control method via a programmable logic controller.

### DESCRIPTION OF RELATED ART

With the development of the computer industry, operating frequencies of most components in computer systems obtain very high performance and generate a great deal of heat. If the heat is not dissipated in a timely fashion, the computer system may be seriously damaged. A fan is usually used to lower a temperature of the computer system.

Higher a fan speed the fan operates, higher a heat dissipation efficiency the fan may achieve. However, operating at a high fixed fan speed adds noise and consumes a great deal of energy, which is wasteful and unnecessary when the heat generated within a computer enclosure is at a minimum. Therefore, it is necessary to better control the fan speed.

Furthermore, a conventional fan speed control circuit only can control one fan speed. When multiple fans are used, each fan needs a fan speed control circuit, which may be expensive. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a step view of a fan control system in one embodiment.

FIG. 2 is an illustrate circuit view of the fan control system in one embodiment.

FIG. 3 is a flow chart illustrating a fan control method in one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

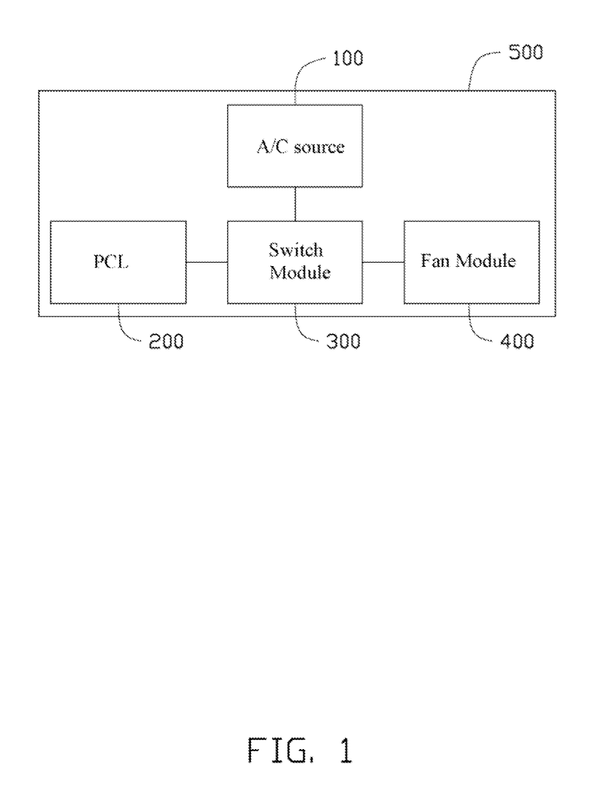

FIG. 1 is an one embodiment of a fan control system. The fan control system dissipates heat from a container 500. The fan control system includes an alternative current (A/C) source 100, a programmable logical controller (PLC) 200, a switch module 300 and a fan module 400. The A/C source 100 is connected to the switch module 300. The switch module 300 is connected to the PLC 200 and the fan module 400.

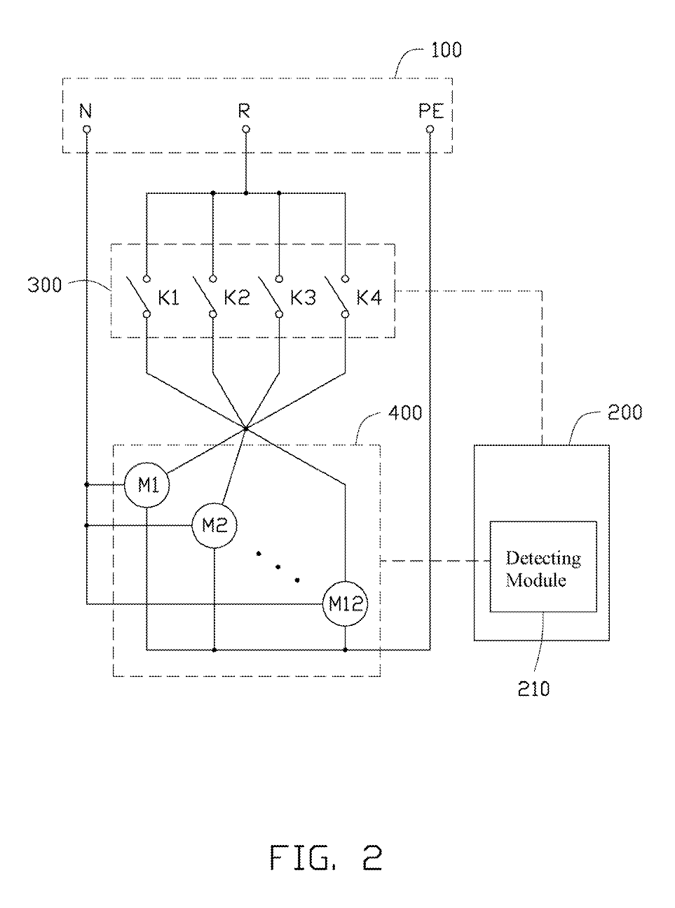

Referring to FIG. 2, the A/C source 100 includes a power line R, a null line N, and a ground line PE. In one embodiment, the switch module 300 includes four switches K1 to K4 connected in parallel.

The four switches K1 to K4 are connected to the power line R of the A/C source 100 and output the power to the fan module 400. The four switches K1 to K4 have different levels of power output. Only one of the four switches K1 to K4 is switched on to output power to the fan module 400. The levels of power output increase from the switch K1 to the switch K4.

The fan module 400 includes a plurality of fans M1, M2, . . . , M12, etc. connected in parallel. Each of the plurality of fans M1, M2, . . . , M12, etc. can receive power from the switch module 300. Each of the plurality of fans M1, M2, . . . , M12, etc. is also connected to the null line N and the ground PE of the A/C source 100. Each of the fans can be an air blower. Each air blower may include a cold channel at an inlet and a hot channel at an outlet. The cold channel and the hot channel are communicated with the fan module 400. The cold channel can input cool airflows to the fan module 400. The hot channel can output hot airflows from the fan module 400. If hot channel has higher air pressure than the cool channel, the container 500 is hot, so the container 500 need better cool by the fan module 400.

The PLC 200 is electrically connected to the switch module 300 to control the conductive state of the four switches K1 to K4 according to high and low level signals. The PLC 200 includes a detecting module 210. The detecting module 210 can detect an ambient temperature of the fan module 400 and an air pressure difference between the cold channels and the hot channels of the fan module 400. The PLC 200 can also calculate the air pressure difference.

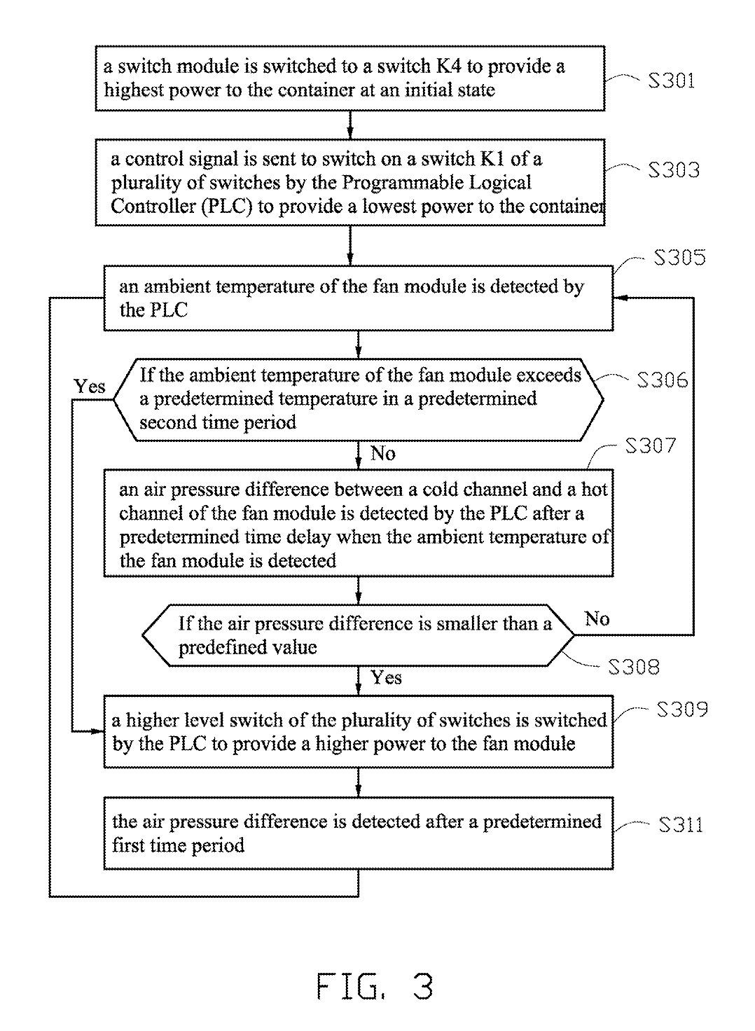

Referring to FIG. 3, in one embodiment, a fan control method of the fan control system includes the following steps.

In step S301: a switch module 300 is switched to a switch K4 to provide a highest power to the container 500 at an initial state, and keeps running for about 3 minutes.

In step S303: a control signal is sent to switch on a switch K1 of a plurality of switches 300 by a Programmable Logical Controller (PLC) 200 to provide a lowest level of power output to the container 500.

In step S305: an ambient temperature of the fan module 400 is detected by the PLC 200.

In step S306: if the ambient temperature of the fan module 400 exceeds a predetermined temperature in a predetermined second time period, go to step S309.

In step S307: an air pressure difference between a cold channel and a hot channel of the fan module 400 is detected by the PLC 200 after a predetermined delay time period when the ambient temperature of the fan module 400 is detected.

In step S308: if the air pressure difference is smaller than a predefined value, go to step S309; if the air pressure difference is greater than the predefined value, go back to step S305.

In step S309: a higher level switch of the plurality of switches K1 to K4 is switched by the PLC 200 to provide a higher power to the fan module 400.

In step S311: the air pressure difference is detected after a predetermined first time period, S305 is repeated. In one embodiment, the predetermined first time period is about 30 seconds.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A fan control method, comprising:
controlling a level of power output of a fan module by a plurality of switches;
switching on one of the plurality of switches by sending a control signal from a programmable logical controller (PLC);
detecting an ambient temperature of the fan module and detecting an air pressure difference between a cold channel and a hot channel, wherein the fan module is communicated with the cold channel, and the cold channel is configured to input cool airflows to a heat element, and the hot channel is configured to output hot airflows from the heat element;
if an air pressure difference between the hot channel and the cold channel is smaller than a predefined value, switching the plurality of switches by the PLC to provide a higher power output to the fan module.

2. The method of the claim 1 further comprising continuing detecting the air pressure difference in a predetermined first time period after switching the plurality of switches by the PLC.

3. The method of the claim 2, wherein the predetermined first time period is about 30 seconds.

4. The method of the claim 1 further comprising if the air pressure difference is greater than the predefined value, returning to detect the ambient temperature of the fan module.

5. The method of the claim 1, further comprising switching the plurality of switches by the PLC, if the ambient temperature of the fan module exceeds a predetermined temperature in a predetermined second time period.

6. The method of the claim 1, wherein the plurality of switches comprises four switches, each of the four switches being adapted to operate at a different level of power output, and only one of the four switches is switched on at a time.

7. The method of the claim 6, further comprising operating one of the plurality of switches at a highest level of power output as an initial state of the fan module.

8. The method of the claim 7, further comprising switching to another one of the plurality of switches at a lowest level of power output after operating the plurality of switches at the highest level of power output for about 3 minutes.

9. A fan control system, comprising:
an alternative current (A/C) source;
a programmable logical controller (PLC), comprising a detecting module;
a switch module connected to the A/C source; and
a fan module connected to the switch module, and the fan module comprising a plurality of fans,
wherein the PLC is adapted to control the switch module thereby changing a level of power output to the fan module, according to an ambient temperature of the fan module and an air pressure difference between a cold channel and a hot channel of the fan module; the fan module is communicated with the cold channel, and the cold channel is configured to input cool airflows to a heat element, and the hot channel is configured to output hot airflows from the heat element, and if the air pressure difference is smaller than a predefined value, the plurality of switches are switched by the PLC to provide a higher level of power output to the fan module.

10. The fan control system of the claim 9, wherein the PLC is adapted to continue detecting the air pressure difference in a predetermined first time period after switching the plurality of switches to provide the higher level of power output to the fan module by the PLC.

11. The fan control system of the claim 10, wherein the predetermined first time period is about 30 seconds.

12. The fan control system of the claim 9, wherein the PLC continue to detect the ambient temperature of the fan module, if the air pressure difference is greater than the predefined value.

13. The fan control system of the claim 9, wherein the PLC is further adapted to switch the plurality of switches, if the ambient temperature of the fan module exceeds a predetermined temperature in a predetermined second time period.

14. The fan control system of the claim 9, wherein the plurality of switches comprises four switches, each of the four switched being adapted to operate at a different level of power output, and only one of the four switches is switched on at a time.

15. The fan control system of the claim 9, wherein the PLC is further adapted to switch the plurality of switches to operate at a highest level of power output at an initial state of the fan module.

16. The fan control system of the claim 15, wherein the PLC is further adapted to switch another one the plurality of switches to operate at an original level of power output after continuing operating the plurality of switches at the highest level of power output for about 3 minutes.
